(19) United States
(12) Patent Application Publication
(10) Pub. No.: US 2025/0292726 A1
(43) Pub. Date: Sep. 18, 2025

(54) DISPLAY DEVICE

(71) Applicant: Xiamen Tianma Display Technology Co., Ltd., Xiamen (CN)

(72) Inventor: Ke XIONG, Xiamen (CN)

(73) Assignee: Xiamen Tianma Display Technology Co., Ltd., Xiamen (CN)

(21) Appl. No.: 19/096,177

(22) Filed: Mar. 31, 2025

(30) Foreign Application Priority Data
Oct. 28, 2024 (CN) 202411513917.1

(51) Int. Cl. G09G 3/32

(52) U.S. Cl. CPC G09G 3/32; G09G 2300/0842; G09G 2300/0861; G09G 2310/08; G09G 2320/0247; G09G 2330/021; G09G 2330/025; G09G 2330/026

(57) ABSTRACT

A display device includes display panel, power management circuit, and display driving circuit. The display panel includes display area and non-display area at least partially surrounding the display area. The display area provided with multiple pixels arranged in array. A pixel at least includes light-emitting element and reset module electrically connected to first electrode of the light-emitting element. The power management circuit disposed in the non-display area and at least configured to provide first power signal to second electrode of the light-emitting element. The display driving circuit disposed in the non-display area and at least configured to provide reset signal to the reset module. The working process of the display device at least includes power-on stage in which, difference between the voltage of the reset signal and the voltage of the first power signal is ΔVb, and the turn-on voltage of the light-emitting element is V0, where |ΔVb|<V0.

### CROSS-REFERENCE TO RELATED APPLICATION(S)

This application claims priority to Chinese Patent Application No. 202411513917.1 filed Oct. 28, 2024, the disclosure of which is incorporated herein by reference in its entirety.

### TECHNICAL FIELD

The present disclosure relates to the field of display technologies, in particular, to a display device.

### BACKGROUND

A display device typically includes a display panel, along with a driving circuit and a power circuit arranged on the display panel. The driving circuit provides driving signals to the display panel, while the power circuit supplies power signals to the display panel. Under the combined control of the driving signals and power signals, the display panel is capable of rendering images.

In the power-on process of the display device, such as in the booting process, the driving circuit usually provides the display panel with driving signals corresponding to a 0-grayscale image, enabling the display panel to present a black image. However, in the power-on process, the power signals output from the power circuit fluctuate and change instantaneously, thereby causing the display device to flash and affecting the display effect of the display device.

### SUMMARY

The present disclosure provides a display device to address the problem of screen flickering in the power-on stage of the display device, thereby improving the display effect of the display device.

The display device provided includes a display panel, a power management circuit, and a display driving circuit.

The display panel includes a display area and a non-display area at least partially surrounding the display area. The display area is provided with multiple pixels arranged in array. A pixel includes a reset module and a light-emitting element. The reset module is electrically connected to a first electrode of the light-emitting element.

The power management circuit is disposed in the non-display area. The power management circuit is at least configured to provide a first power signal to a second electrode of the light-emitting element.

The display driving circuit is disposed in the non-display area. The display driving circuit is at least configured to provide a reset signal to the reset module.

The working process of the display device at least includes a power-on stage. In the power-on stage, the difference between the voltage of the reset signal and the voltage of the first power signal is ΔVb. The turn-on voltage of the light-emitting element is V0, where |ΔVb|<V0.

### BRIEF DESCRIPTION OF DRAWINGS

FIG. 1 is a diagram illustrating the structure of a display device according to an embodiment of the present disclosure.

FIG. 2 is a diagram illustrating the structure of a pixel circuit according to an embodiment of the present disclosure.

FIG. 3 is a driving timing diagram of a display device in the related art.

FIG. 4 is another diagram illustrating the structure of the display device according to an embodiment of the present disclosure.

FIG. 5 is another diagram illustrating the structure of a pixel circuit according to an embodiment of the present disclosure.

FIG. 6 is a driving timing diagram of pixels in a display device according to an embodiment of the present disclosure.

FIG. 7 is a driving timing diagram of a display device according to an embodiment of the present disclosure.

FIG. 8 is another driving timing diagram of the display device according to an embodiment of the present disclosure.

FIG. 9 is still another driving timing diagram of the display device according to an embodiment of the present disclosure.

FIG. 10 is still another driving timing diagram of the display device according to an embodiment of the present disclosure.

FIG. 11 is a driving timing diagram of a display device according to an embodiment of the present disclosure.

FIG. 12 is another driving timing diagram of the display device according to an embodiment of the present disclosure.

FIG. 13 is still another driving timing diagram of the display device according to an embodiment of the present disclosure.

FIG. 14 is still another driving timing diagram of the display device according to an embodiment of the present disclosure.

FIG. 15 is a driving timing diagram of a display device according to an embodiment of the present disclosure.

FIG. 16 is another driving timing diagram of the display device according to an embodiment of the present disclosure.

FIG. 17 is still another driving timing diagram of the display device according to an embodiment of the present disclosure.

FIG. 18 is another diagram illustrating the structure of the display device according to an embodiment of the present disclosure.

FIG. 19 is still another driving timing diagram of the display device according to an embodiment of the present disclosure.

FIG. 20 is a driving timing diagram of a display device according to an embodiment of the present disclosure.

FIG. 21 is another diagram illustrating the structure of the display device according to an embodiment of the present disclosure.

### DETAILED DESCRIPTION

Hereinafter the present disclosure is further described in detail in conjunction with the drawings and embodiments. It is to be understood that the embodiments described herein are only intended to illustrate but not to limit the present disclosure. Additionally, it is to be noted that for ease of description, only part, not all, of structures related to the present disclosure are illustrated in the drawings.

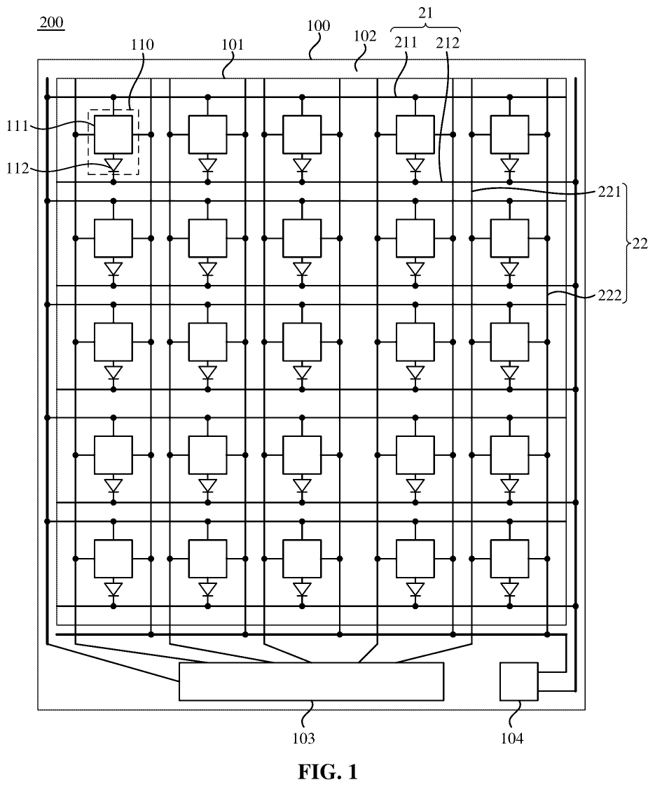

FIG. 1 is a diagram illustrating the structure of a display device according to an embodiment of the present disclosure. FIG. 2 is a diagram illustrating the structure of a pixel circuit according to an embodiment of the present disclosure. With reference to FIG. 1 and FIG. 2, the display device 200 includes a display panel 100, the display panel 100 includes a display area 101, and the display area 101 is provided with multiple pixels 110 arranged in array; a pixel 110 includes a pixel circuit 111 and a light-emitting element 112; the pixel circuit 111 at least includes a reset module 15 electrically connected to a first electrode of the light-emitting element 112. In this manner, the reset module 15 can reset the first electrode of the light-emitting element 112 to clear a signal written to the first electrode of the light-emitting element 112. Thus, when entering the light-emitting stage of the pixel 110, the light-emitting element 112 can accurately emit light.

The display device 200 may also include a power management circuit 104 and a display driving circuit 103. In this case, the display panel 100 may also include a non-display area 102 at least partially surrounding the display area 101, and the power management circuit 104 and the display driving circuit 103 may both be disposed in the non-display area 102. The power management circuit 104 is at least configured to provide a first power signal to a second electrode of the light-emitting element 112. The display driving circuit 103 is at least configured to provide a reset signal to the reset module 15.

The non-display area 102 at least partially surrounds the display area 101, which may be understood as that the non-display area 102 is disposed around the display area 101 or the non-display area 102 is located on one or more sides of the display area 101. The non-display area 102 may be specifically designed as required, and embodiments of the present disclosure do not impose specific limitations.

It can be understood that when the display device 200 needs to be started, the power-on stage of the display device 200 is first entered, that is, the working process of the display device 200 at least includes a power-on stage. In the power-on stage, the display driving circuit 103, the power management circuit 104, and each node of each pixel 110 need to be charged or discharged. In this manner, the signals output from the display driving circuit 103 and the power management circuit 104 are unstable, and the signals provided to each pixel 110 are unstable. Consequently, when the pixel 110 is controlled to emit light in the power-on stage, the pixel 110 cannot accurately display light, which affects the display effect of the display device 200. Therefore, in the power-on stage, the display driving circuit 103 controls the display panel 100 to display a black image, that is, the display brightness of each pixel 110 is 0 grayscale.

Based on the above reasons, in the power-on stage, the display driving circuit 103 starts to provide a reset signal Vref2 to the reset module 15 of each pixel 110, and moreover, the display driving circuit 103 may also control the reset module 15 to transmit the reset signal Vref2 to the first electrode of the light-emitting element 112 to reset the first electrode of the light-emitting element 112 so that when the light-emitting element 112 emits light for display, it can be ensured that the display driving signal can be accurately provided to the first electrode of the light-emitting element 112, and at this time, the signal of the first electrode of the light-emitting element 112 is consistent with the reset signal Vref2; meanwhile, the power management circuit 104 provides a first power signal PVEE to the second electrode of the light-emitting element 112 to charge or discharge the second electrode of the light-emitting element 112 to prepare for subsequent display and light emission, and at this time, the signal of the second electrode of the light-emitting element 112 can be consistent with the first power signal PVEE provided by the power management circuit 104. However, when the power-on stage is entered, the first power signal output from the power management circuit 104 at the moment of power-on experiences instantaneous fluctuations, and the instantaneous fluctuations affect the accuracy of the first power signal provided to the second electrode of the light-emitting element 112.

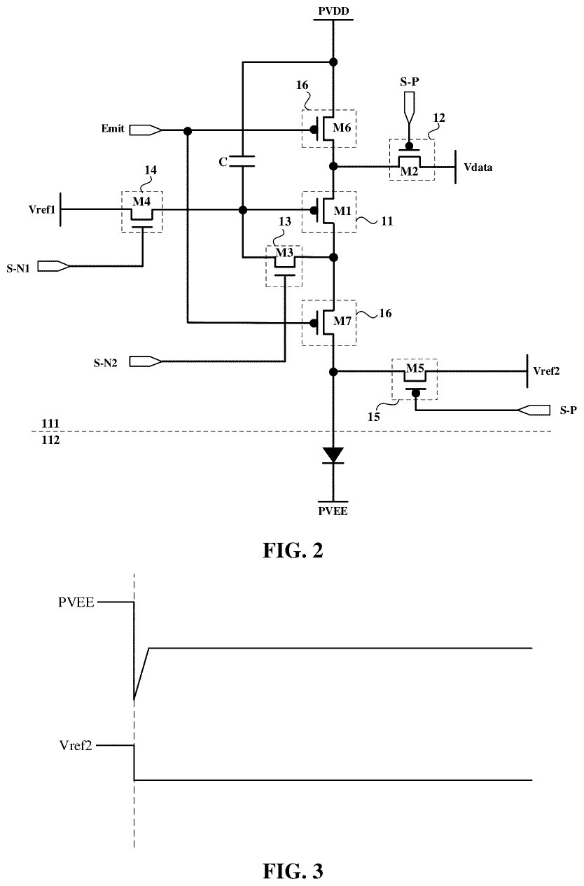

For example, FIG. 3 is a driving timing diagram of a display device in the related art. With reference to FIG. 1 to FIG. 3, when the light-emitting element 112 includes a light-emitting diode, the first electrode may be an anode of the light-emitting diode, and the second electrode may be a cathode of the light-emitting diode. At the moment of power-on, if the first power signal is a relatively negative pulse signal due to the instantaneous fluctuation of the first power signal, the difference between the voltage of the first electrode signal and the voltage of the second electrode signal of the light-emitting element 112 is greater than the turn-on voltage of the light-emitting element 112, which will cause the light-emitting element 112 to perform display and emit light. As a result, in the power-on stage, the instantaneous light emission of the light-emitting element 112 can cause the display device 200 to show a momentary non-black screen in the period when a black screen is required. That is, the display brightness of the pixels 110 in the display panel 100 exceeds 0 grayscale, leading to screen flickering in the display device 200 and affecting the display effect of the display device 200.

To solve the above technical problems, in the embodiments of the present disclosure, in the power-on stage of the display device 200, when the difference between the voltage of the reset signal Vref2 provided by the display driving circuit 103 and the voltage of the first power signal provided by the power management circuit 104 is ΔVb, and the turn-on voltage of the light-emitting element 112 is V0, it is possible that |ΔVb|<V0.

The turn-on voltage V0 of the light-emitting element 112 is the minimum voltage difference between the anode and the cathode of the light-emitting element 112 when the light-emitting element 112 is capable of emitting light. The turn-on voltage V0 is usually a positive value, and in this case, the value range of ΔVb may be as follows: −V0<ΔVb<V0.

As shown in FIG. 2, in the case where the first electrode is the anode of the light-emitting element 112 and the second electrode is the cathode of the light-emitting element 112, the first power signal may be a negative power signal PVEE. Therefore, in the power-on stage, the reset signal Vref2 provided by the display driving circuit 103 may be controlled to be less than the first power signal PVEE provided by the power management circuit 104 so that the voltage difference ΔVb between the reset signal Vref2 of the first electrode of the light-emitting element 112 and the first power signal PVEE of the second electrode of the light-emitting element 112 is a negative value. That is, the voltage difference between the anode signal of the light-emitting element 112 and the cathode signal of the light-emitting element 112 is a negative value so that the voltage difference between the anode signal of the light-emitting element 112 and the cathode signal of the light-emitting element 112 is less than the turn-on voltage V0 of the light-emitting element 112, thereby ensuring that the light-emitting element 112 cannot display light. Alternatively, the reset signal Vref2 provided by the display driving circuit 103 may also be greater than or equal to the first power signal PVEE provided by the power management circuit 104. In this case, as long as the difference between the reset signal Vref2 and the first power signal PVEE is small enough, it can be ensured that the voltage difference between the reset signal Vref2 of the anode of the light-emitting element 112 and the first power signal PVEE of the cathode of the light-emitting element 112 is less than the turn-on voltage V0 of the light-emitting element 112, and the light-emitting element 112 cannot display light.

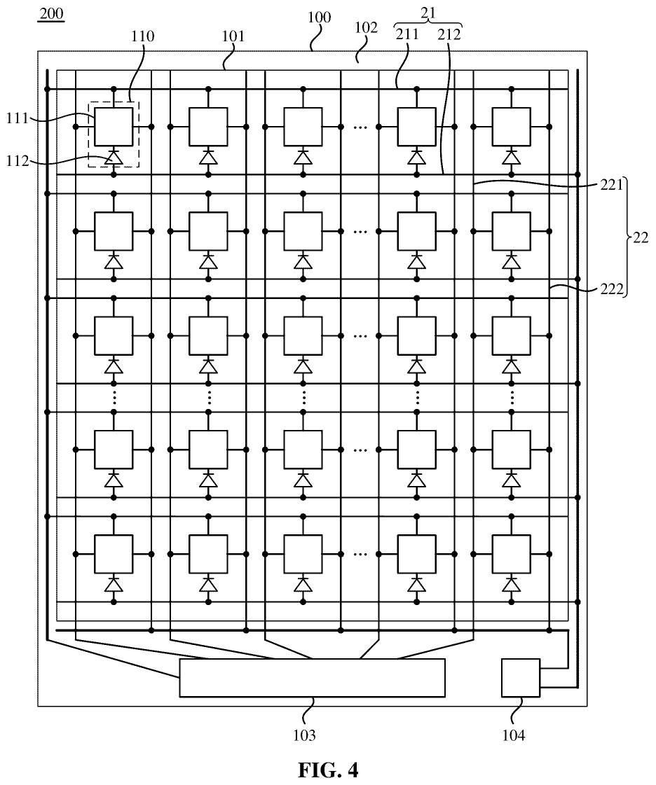

It should be noted that the above only exemplarily illustrates that the reset signal provided by the display driving circuit 103 and the first power signal provided by the power management circuit 104 in the power-on stage, with an example where the first electrode of the light-emitting element 112 is used as the anode of the light-emitting element 112 and the second electrode of the light-emitting element 112 is used as the cathode of the light-emitting element 112. In the embodiment of the present disclosure, as shown in FIG. 4, the second electrode of the light-emitting element 112 may also be the anode of the light-emitting element 112, and the first electrode of the light-emitting element 112 may be the cathode of the light-emitting element 112.

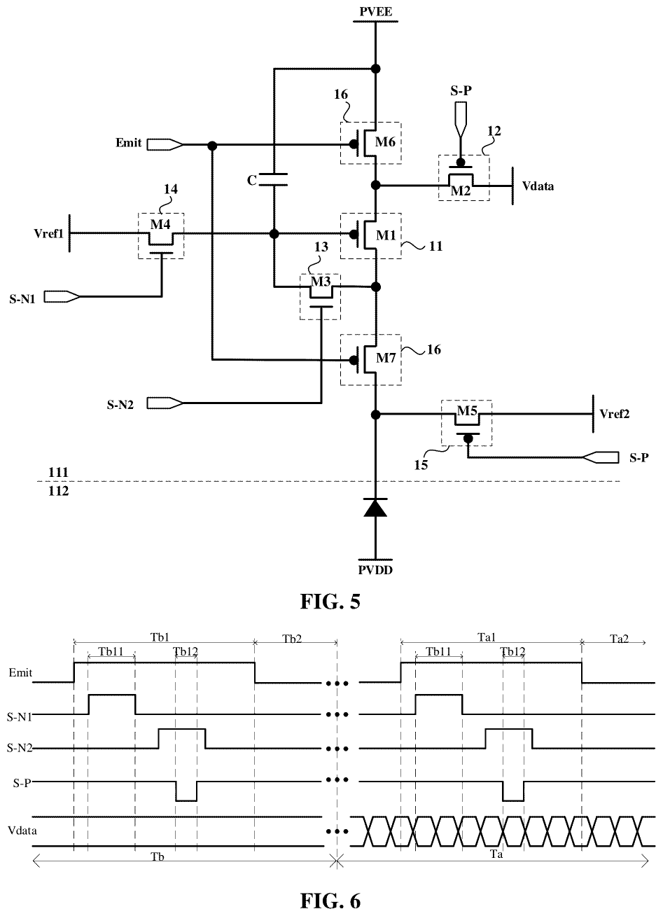

With reference to FIG. 4 and FIG. 5, in the case where the second electrode of the light-emitting element 112 is the anode of the light-emitting element and the first electrode of the light-emitting element 112 is the cathode of the light-emitting element 112, the first power signal may be a positive power signal PVDD. In this case, in the power-on stage, the reset signal Vref2 provided by the display driving circuit 103 may be controlled to be greater than the first power signal PVDD provided by the power management circuit 104 so that the difference ΔVb between the first power signal PVDD of the second electrode of the light-emitting element 112 and the reset signal Vref2 of the first electrode of the light-emitting element 112 is a negative value. That is, the voltage difference between the anode signal of the light-emitting element 112 and the cathode signal of the light-emitting element 112 is a negative value so that the voltage difference between the anode of the light-emitting element 112 and the cathode of the light-emitting element 112 is less than the turn-on voltage V0 of the light-emitting element 112, thereby ensuring that the light-emitting element 112 cannot display light. Alternatively, the reset signal Vref2 provided by the display driving circuit 103 may also be less than the first power signal PVDD provided by the power management circuit 104. In this case, as long as the difference between the first power signal PVDD and the reset signal Vref2 is small enough, it can be ensured that the voltage difference between the first power signal PVDD of the anode of the light-emitting element 112 and the reset signal Vref2 of the cathode of the light-emitting element 112 is less than the turn-on voltage V0 of the light-emitting element 112, and the light-emitting element 112 cannot display light.

With the above technical solution adopted, in the power-on stage, the power management circuit is controlled to provide the voltage of the first power signal to the light-emitting element, and the display driving circuit is controlled to provide the voltage of the reset signal to the reset module so that the absolute value of the difference between the voltage of the reset signal provided to the first electrode of the light-emitting element of the display panel and the voltage of first power signal provided to the second electrode of the light-emitting element of the display panel is less than the turn-on voltage of the light-emitting element. In this manner, the light-emitting element cannot emit light in the power-on stage, and it is ensured that the display brightness of the light-emitting element is 0 grayscale, thereby avoiding the problem of screen flickering in the power-on stage of the display device and improving the display effect of the display device.

Based on the above embodiments, in one or more embodiments, with continued reference to FIG. 1, FIG. 2, FIG. 4, and FIG. 5, the working process of the display device 200 also includes a displaying stage. In the displaying stage, the difference between the voltage of the reset signal Vref2 and the voltage of the first power signal (PVEE or PVDD) is ΔVa, where |ΔVa|<V0. In this manner, the absolute value of the difference ΔVa between the voltage of the reset signal Vref2 and the voltage of the first power signal in the display stage is less than the turn-on voltage V0 of the light-emitting element 112, to ensure that the light-emitting element 112 can be reset normally, and the signal provided to the first electrode of the light-emitting element 112 in the previous display driving cycle is prevented from affecting the light-emitting accuracy of the light-emitting element 112 in the next light-emitting stage, thereby improving the display reliability of the display device 200 in the display stage and improving the display effect of the display device 200.

It can be understood that in the displaying stage, the absolute value |ΔVa| of the difference between the voltage of the reset signal Vref2 and the voltage of the first power signal (PVEE or PVDD) is less than the turn-on voltage V0 of the light-emitting element 112, and in the power-on stage, the absolute value |ΔVb| of the difference between the voltage of the reset signal Vref2 and the voltage of the first power signal (PVEE or PVDD) is less than the turn-on voltage V0 of the light-emitting element 112. In this case, |ΔVa| and |ΔVb| may be the same or different, and the embodiment of the present disclosure does not impose specific limitations.

In one or more embodiments, |ΔVb|≤|ΔVa|. In this manner, |ΔVb| in the power-on stage is set to be less than or equal to |ΔVa| in the display stage so that in the power-on stage, the absolute value |ΔVa| between the voltage of the reset signal Vref2 and the voltage of the first power signal (PVEE or PVDD) is smaller, thereby ensuring that the light-emitting element 112 cannot emit light in the power-on stage. Moreover, the problem of screen flickering is avoided in the power-on stage of the display device 200, the display effect of the display device 200 is enhanced, and the user experience is improved.

In one or more embodiments, with reference to FIG. 1, FIG. 2, and FIG. 4, when the working process of the display device 200 also includes a displaying stage, the display driving circuit 103 may also be configured to provide a respective data signal Vdata for each pixel 110 in the displaying stage. In this case, the pixel 110 also includes a drive module 11, and the drive module 11 is configured to selectively provide a drive current to the light-emitting element 112 based on the respective data signal Vdata.

It can be understood that the light-emitting element 112 is usually a current-type driving element. That is when the display driving signal provided to the light-emitting element 112 is a drive current, the light-emitting element 112 can be driven to emit light. However, the data signal Vdata provided by the display driving circuit 103 is usually a voltage signal. In this case, a drive module 11 needs to be disposed in the pixel circuit 111 of the pixel 110 so that the drive module 11 can convert the data signal Vdata into a drive current. When the drive current is provided to the light-emitting element 112, the light-emitting element 112 can display light based on the drive current, and generally, the larger the drive current, the higher the light-emitting brightness of the light-emitting element 112. In this manner, by providing the data signals Vdata to each pixel 110, the display brightness of each pixel 110 can be controlled so that the display panel 100 can display a colorful image.

The drive module 11 and the light-emitting element 112 may be connected in series between the positive power signal PVDD and the negative power signal PVEE so that when a conductive path is formed between the positive power signal PVDD and the negative power signal PVEE, the drive current generated by the drive module 11 can be transmitted to the light-emitting element 112 to drive the light-emitting element 112 to emit light.

In addition, with reference to FIG. 1 or FIG. 4, multiple first signal lines 21 and multiple second signal lines 22 may be disposed in the display area 101 of the display panel 100, at least some pixels 110 located in the same row may be electrically connected to the same first signal line 21, and at least some pixels 110 located in the same column may be electrically connected to the same second signal line 22. The first signal line 21 may include a reset signal line 211 configured to transmit a reset signal Vref2 and a first power signal line 212 configured to transmit a first power signal. The second signal line 22 may include a data signal line 221 configured to transmit a data signal Vdata and a second power signal line 222 configured to transmit a second power signal. In this manner, the first power signal and the reset signal Vref2 may be provided to each pixel 110, and the second power signal and the data signal may be provided to each pixel 110. When the first power signal is the positive power signal PVDD, the second power signal may be the negative power signal PVEE; when the first power signal is the negative power signal PVEE, the second power signal may be the positive power signal PVDD.

It should be noted that FIG. 1 and FIG. 4 only exemplarily show that the first signal line includes the first power signal line and the second signal line includes the second power signal line. In one or more other embodiments, the first signal line may include the second power signal line, and the second signal line includes the first power signal line; alternatively, the first signal line may include both the first power signal line and the second power signal line, or the second signal line may include both the first power signal line and the second power signal line.

In addition, since the first electrodes of the light-emitting elements of each pixel receive the first power signal so that the first electrodes of the light-emitting elements of each pixel receive the same signal, and the first electrodes of the light-emitting elements of each pixel may be an integral structure. In this case, the first power signal line may be disposed in the non-display area of the display panel and is electrically connected to the first electrodes of the light-emitting elements extending into the non-display area via vias or similar structures in the non-display area. Thus, the light-emitting elements of each pixel can receive the first power signal transmitted by the first power signal line located in the non-display area. The arrangement of the signal lines in the display panel may be specifically set as required, and the embodiment of the present disclosure does not impose specific limitations.

In one or more embodiments, with continued reference to FIG. 1, FIG. 2, and FIG. 4, the pixel 110 may also include a data writing module 12, and in the same pixel 110, the data writing module 12 can control the data signal provided by the display driving circuit 103 to be written into the drive module 11. The data writing module 12 may be turned on or off under the control of a scan signal S-P, and when the data writing module 12 is turned on, the data signal Vdata may be transmitted to the drive module 11 through the data writing module 12, thereby achieving the writing of the data signal Vdata.

In one or more embodiments, with reference to FIG. 2 or FIG. 4, the pixel 110 may also include a compensation module 13, an initialization module 14, and a light emission control module 16. The drive module 11 may include a drive transistor M1. In this case, the data signal Vdata transmitted by the data writing module 12 is controlled to be written to the gate of the drive transistor M1 so that the drive transistor M1 can generate a corresponding drive current based on the gate signal of the drive transistor M1 and selectively provide the drive current to the light-emitting element 112 to control the light-emitting element 112 to emit light. The compensation module 13 compensates the threshold voltage of the drive transistor M1 to the gate of the drive transistor M1 so that the drive current generated by the drive transistor M1 based on the gate signal of the drive transistor M1 can be independent of the threshold voltage of the drive transistor M1, and the threshold voltage drift of the drive transistor M1 is prevented from affecting the accuracy of the drive current generated by the drive transistor M1. The initialization module 14 can initialize the gate of the drive transistor M1 to prepare for writing the data signal Vdata. The light emission control module 16 can control the time for providing the drive current to the light-emitting element 112 to control the light emission time of the light-emitting element 112.

The data writing module 12 may include a writing transistor M2. A first electrode of the writing transistor M2 is electrically connected to a first electrode of the drive transistor M1, a second electrode of the writing transistor M2 may receive the data signal Vdata, and a gate of the writing transistor M2 may receive the scan signal S-P. The scan signal S-P may control the writing transistor M2 to be turned on or off so that the data signal Vdata can be written to the drive module 11 when the writing transistor M2 is in a turn-on state.

The compensation module 13 may include a compensation transistor M3. A first electrode of the compensation transistor M3 may be electrically connected to the gate of the drive transistor M1, a second electrode of the compensation transistor M3 may be electrically connected to a second electrode of the drive transistor M1, and a gate of the compensation transistor M3 may receive a scan signal S-N2. The scan signal S-N2 may control the compensation transistor M3 to be turned on or turned off so that the data signal Vdata can be controlled to be transmitted to the gate of the drive transistor M1 when the compensation transistor M3 is in a turn-on state, and the threshold voltage of the drive transistor M1 can be compensated to the gate of the drive transistor M1.

The initialization module 14 may include an initialization transistor M4. A first electrode of the initialization transistor M4 is electrically connected to the gate of the drive transistor M1, a second electrode of the initialization transistor M4 receives an initialization signal Vref1, and a gate of the initialization transistor M4 receives a scan signal S-N1. The scan signal S-N1 may control the initialization transistor M4 to be turned on or turned off so that the initialization signal Vref1 can be provided to the gate of the drive transistor M1 when the initialization transistor M4 is in a turn-on state.

The light emission control module 16 may include a first light emission control transistor M6 and a second light emission control transistor M7. A gate of the first light emission control transistor M6 and a gate of the second light emission control transistor M7 both receive a light emission control signal Emit. A first electrode of the first light emission control transistor M6 receives the second power signal, and a second electrode of the first light emission control transistor M6 is electrically connected to a first electrode of the drive transistor M1. A first electrode of the second light emission control transistor M7 is electrically connected to the second electrode of the drive transistor M1, and a second electrode of the second light emission control transistor M7 is electrically connected to the first electrode of the light-emitting element 112. In this manner, the light emission control signal Emit can control the first light emission control transistor M6 and the second light emission control transistor M7 to be turned on or off at the same time.

The reset module 15 may include a reset transistor M5. A first electrode of the reset transistor M5 may receive a reset signal Vref2, a second electrode of the reset transistor M5 is electrically connected to the first electrode of the light-emitting element 112, and a gate of the reset transistor M5 may receive the scan signal S-P. The reset transistor M5 may be turned on or off under the control of the scan signal S-P so that when the scan signal S-P controls the reset transistor M5 to be turned on, the reset signal Vref2 may be transmitted to the first electrode of the light-emitting element 112 to reset the first electrode of the light-emitting element 112.

The pixel circuit 111 also includes a storage capacitor. The storage capacitor C is electrically connected between a fixed power signal and the gate of the drive transistor M1 and is configured to store the gate potential of the drive transistor M1 to ensure that the drive transistor M1 can continuously provide a drive current for the light-emitting element 112 in the light-emitting stage. The fixed power signal may reuse the first power signal or the second power signal and may be designed as required. The embodiment of the present disclosure does not impose specific limitations.

It can be understood that each transistor in the pixel circuit 111 may be an NMOS transistor or a PMOS transistor, and the specific type may be designed as required. The embodiment of the present disclosure does not impose specific limitations. For NMOS transistors, NMOS transistors turn on when the signal received by the gate is at a high level and turn off when the signal received by the gate is at a low level. For PMOS transistors, PMOS transistors turn on when the signal received by the gate is at a low level and turn off when the signal received by the gate is at a high level. For ease of description, without special limitations, the technical solutions of the embodiments of the present disclosure are described using an example where the drive transistor M1, the writing transistor M2, the reset transistor M5, the first light emission control transistor M6, and the second light emission control transistor M7 are all PMOS transistors and the initialization transistor M4 and the compensation transistor M3 are NMOS transistors in the embodiments of the present disclosure.

In an example embodiment, an example is used where the first power signal is the negative power signal PVEE and the second power signal is the positive power signal PVDD. FIG. 6 is a driving timing diagram of pixels in a display device according to an embodiment of the present disclosure. With reference to FIG. 2 and FIG. 6, the power-on stage Tb of the pixel 110 may include a power-on non-light-emitting stage Tb1 and a power-on light-emitting stage Tb2, and the display stage Ta of the pixel 110 may include a display non-light-emitting stage Ta1 and a display light-emitting stage Ta2.

In the power-on stage Tb and the display stage Ta, the display driving circuit 103 may control the signals (the scan signal S-P, the scan signal S-N, and the light emission control signal Emit, the reset signal Vref2, the initialization signal Vref1, and the data signal Vdata) received by the gates of the transistors in the pixel circuit 111, and the power management circuit 104 may provide the second power signal PVDD to the pixel circuit 111 and provide the first power signal PVEE to the light-emitting element 112.

When entering a first non-light-emitting stage Tb11 of the power-on non-light-emitting stage Tb1 in the power-on stage Tb, the display driving circuit 103 may control the first light emission control transistor M6 and the second light emission control transistor M7 in the pixel circuit 111 to receive the high-level light emission control signal Emit, the writing transistor M2 and the reset transistor M5 to receive the high-level scan signal S-P, the compensation transistor M3 to receive the low-level scan signal S-N1, and the initialization transistor M4 to receive the high-level scan signal S-N2. Thus, the writing transistor M2, the reset transistor M5, the compensation transistor M3, the first light emission control transistor M6, and the second light emission control transistor M7 are all in the turn-off state, the initialization transistor M4 is in the turn-on state, and the initialization signal Vref1 provided by the display driving circuit 103 can be written to the gate of the drive transistor M1 to initialize the gate of the drive transistor M1. When entering a second non-light-emitting stage Tb12 of the power-on non-light-emitting stage Tb1 in the power-on stage Tb, the display driving circuit 103 may control the first light emission control transistor M6 and the second light emission control transistor M7 in the pixel circuit 111 to continue to receive the high-level light emission control signal Emit, the writing transistor M2 and the reset transistor M5 to receive the low-level scan signal S-P, the compensation transistor M3 to receive the high-level scan signal S-N1, and the initialization transistor M4 to receive the low-level scan signal S-N2. Thus, the writing transistor M2, the reset transistor M5, and the compensation transistor M3 are in the turn-on state, the initialization transistor M4, the first light emission control transistor M6, and the second light emission control transistor M7 are in the turn-off state, the data signal Vdata corresponding to the 0 grayscale can be written to the gate of the drive transistor M1, the threshold voltage of the drive transistor M1 is compensated to the gate of the drive transistor M1, and meanwhile, the reset signal Vref2 can be written to the first electrode of the light-emitting element 112. Since the absolute value of the difference between the reset signal Vref2 and the first power signal PVEE is less than the turn-on voltage V0 of the light-emitting element 112 at this time, the light-emitting element 112 cannot emit light. When entering the power-on light-emitting stage Tb2 of the power-on stage Tb, the display driving circuit 103 may control the first light emission control transistor M6 and the second light emission control transistor M7 in the pixel circuit 111 to receive the low-level light emission control signal Emit, the writing transistor M2 and the reset transistor M5 to receive the high-level scan signal S-P, the compensation transistor M3 to receive the low-level scan signal S-N1, and the initialization transistor M4 to receive the low-level scan signal S-N2. Thus, the writing transistor M2, the reset transistor M5, the compensation transistor M3, and the initialization transistor M4 are all in the turn-off state, the first light emission control transistor M6 and the second light emission control transistor M7 are in the turn-on state, a current path is formed between the first power signal PVEE and the second power signal PVDD, and the drive transistor M1 can provide the drive current corresponding to the 0 grayscale to the light-emitting element 112. In this manner, the light-emitting element 112 displays the light-emitting brightness of 0 grayscale, and the display panel 100 displays a black screen.

It can be understood that when the drive transistor M1 is a PMOS transistor, compared with the voltage of the data signal Vdata corresponding to other graylevels, the voltage of the data signal Vdata corresponding to 0 graylevel is higher so that in the power-on stage, the voltage of the data signal Vdata is kept at a higher level; on the contrary, when the drive transistor M1 is an NMOS transistor, compared with the voltage of the data signal Vdata corresponding to other graylevels, the voltage of the data signal Vdata corresponding to 0 graylevel is lower so that in the power-on stage, the voltage of the data signal Vdata is kept at a lower level.

Correspondingly, when entering a first non-light-emitting stage Ta11 of the display non-light-emitting stage Ta1 in the display stage Ta, the display driving circuit 103 may control the first light emission control transistor M6 and the second light emission control transistor M7 in the pixel circuit 111 to receive the high-level light emission control signal Emit, the writing transistor M2 and the reset transistor M5 to receive the high-level scan signal S-P, the compensation transistor M3 to receive the low-level scan signal S-N2, and the initialization transistor M4 to receive the high-level scan signal S-N1. Thus, the writing transistor M2, the reset transistor M5, the compensation transistor M3, the first light emission control transistor M6, and the second light emission control transistor M7 are all in the turn-off state, the initialization transistor M4 is in the turn-on state, and the initialization signal Vref1 provided by the display driving circuit 103 can be written to the gate of the drive transistor M1 to initialize the gate of the drive transistor M1. When entering a second non-light-emitting stage Ta12 of the display non-light-emitting stage Ta1 in the display stage Ta, the display driving circuit 103 may control the first light emission control transistor M6 and the second light emission control transistor M7 in the pixel circuit 111 to continue to receive the high-level light emission control signal Emit, the writing transistor M2 and the reset transistor M5 to receive the low-level scan signal S-P, the compensation transistor M3 to receive the high-level scan signal S-N1, and the initialization transistor M4 to receive the low-level scan signal S-N2. Thus, the writing transistor M2, the reset transistor M5, and the compensation transistor M3 are in the turn-on state, the initialization transistor M4, the first light emission control transistor M6, and the second light emission control transistor M7 are in the turn-off state, the data signal Vdata corresponding to the grayscale required to be presented by the pixel can be written to the gate of the drive transistor M1, the threshold voltage of the drive transistor M1 is compensated to the gate of the drive transistor M1, and meanwhile, the reset signal Vref2 can be written to the first electrode of the light-emitting element 112. Since the absolute value of the difference between the reset signal Vref2 and the first power signal PVEE is less than the turn-on voltage V0 of the light-emitting element 112 at this time, the light-emitting element 112 cannot emit light. When entering the display light-emitting stage Ta2 of the display stage Ta, the display driving circuit 103 may control the first light emission control transistor M6 and the second light emission control transistor M7 in the pixel circuit 111 to receive the low-level light emission control signal Emit, the writing transistor M2 and the reset transistor M5 to receive the high-level scan signal S-P, the compensation transistor M3 to receive the low-level scan signal S-N1, and the initialization transistor M4 to receive the low-level scan signal S-N2. Thus, the writing transistor M2, the reset transistor M5, the compensation transistor M3, and the initialization transistor M4 are all in the turn-off state, the first light emission control transistor M6 and the second light emission control transistor M7 are in the turn-on state, a current path is formed between the first power signal PVEE and the second power signal PVDD, and the drive transistor M1 can provide the drive current corresponding to the grayscale required to be displayed by the pixel 110 to the light-emitting element 112. In this manner, the light-emitting element 112 displays the light-emitting brightness of 0 grayscale, and the display panel 100 can display a corresponding screen.

In this manner, in the power-on stage Tb and the display stage Ta, the display driving circuit 103 can maintain a consistent sequence of turning on or off the transistors in the pixel circuit 111 of the pixel 110. Thus, the signals can be correspondingly written into the pixel 110 to achieve power-on and display control of the pixel 110.

It should be noted that the reset transistor M5 may be turned on or off under the control of the scan signal S-P, and when the scan signal S-P controls the reset transistor M5 to be turned on, the reset transistor M5 can transmit the reset signal Vref2 to the first electrode of the light-emitting element 112 to reset the light-emitting element 112. In this case, the turn-on duration of the reset transistor M5 may overlap the turn-on duration of the writing transistor M2. Thus, the time length of the non-light-emitting stage between two adjacent light-emitting stages can be shortened, and the light-emitting stage has a sufficient time length to ensure the display brightness of the display panel 100. In one or more other embodiments, when the type of the reset transistor M5 is the same as the type of the initialization transistor M4, the scan signal received by the reset transistor M5 may also be consistent with the scan signal received by the initialization transistor M4. Thus, the turn-on duration of the reset transistor M5 overlaps the turn-on duration of the initialization transistor M4, the time length of the non-light-emitting stage between two adjacent light-emitting stages can be shortened, and the light-emitting stage has a sufficient time length to ensure the display brightness of the display panel 100.

It should be also noted that the above only exemplarily describes the structure and working process of the pixel, and on the premise that the core invention point of the embodiment of the present disclosure can be implemented, the structure and working process of the pixel may be simple and deformed on the basis of the above embodiments. The structure and working process after simple deformation all fall within the protection of the embodiments of the present disclosure, which is not described one by one herein.

It can be understood that the above only exemplarily describes the technical solutions of the embodiments of the present disclosure, and on the premise that the absolute value of the voltage difference between the reset signal provided by the display driving circuit and the first power signal provided by the power management circuit is less than the turn-on voltage of the light-emitting element, the arrangement of the first power signal provided by the power management circuit and the reset signal provided by the display driving circuit in the power-on stage is not specifically limited in the embodiments of the present disclosure.

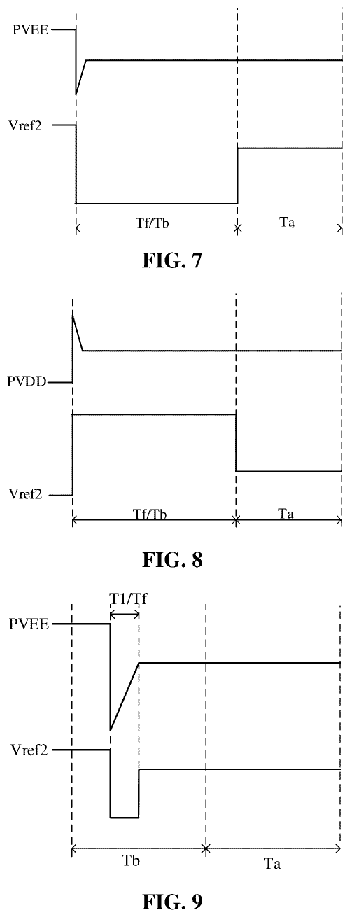

In one or more embodiments, FIG. 7 is a driving timing diagram of a display device according to an embodiment of the present disclosure. FIG. 8 is another driving timing diagram of the display device according to an embodiment of the present disclosure. With reference to FIG. 1, FIG. 2, FIG. 4, FIG. 5, FIG. 7, and FIG. 8, when the working process of the display device also includes a display stage Ta, the power-on stage Tb may include a reset adjustment period Tf, in the reset adjustment period Tf, the voltage of the reset signal Vref2 is V11; in the display stage Ta, the voltage of the reset signal Vref2 is V12, where V11≠V12.

It can be understood that the voltage V11 of the reset signal Vref2 in the reset adjustment period Tf is different from the voltage V12 of the reset signal Vref2 in the display stage Ta, that is, the voltage V11 of the reset signal Vref2 in the reset adjustment period Tf may be greater than the voltage V12 of the reset signal Vref2 in the display stage Ta, or the voltage V11 of the reset signal Vref2 of the reset adjustment period Tf is less than the voltage V12 of the reset signal Vref2 in the display stage Ta. The specific arrangement may be designed as required. On the premise that the voltage difference between the reset signal provided to the first electrode of the light-emitting element 112 and the first power signal (PVEE or PVDD) provided to the second electrode of the light-emitting element 112 in the power-on stage Tb cannot control the light-emitting element 112 to display and emit light, the embodiment of the present disclosure does not impose specific limitations.

Specifically, when the voltage V11 of the reset signal Vref2 in the reset adjustment period Tf is different from the voltage V12 of the reset signal Vref2 in the display stage Ta, after the reset adjustment period Tf of the power-on stage Tb is entered, the display driving circuit 103 may adjust the voltage of the reset signal Vref2 output from the display driving circuit 103. In this manner, the absolute value of the voltage difference between the reset signal Vref2 output at least in the reset adjustment period Tf and the first power signal (PVEE or PVDD) is less than the turn-on voltage V0 of the light-emitting element 112, thereby ensuring that the light-emitting element 112 cannot emit light, preventing the display device 200 from flickering, and improving the display effect of the display device 200.

The specific values of the voltage V12 of the reset signal Vref2 in the display stage Ta and the voltage V11 of the reset signal Vref2 in the reset adjustment period Tf may be set as required. Exemplarily, with reference to FIG. 1, FIG. 2, and FIG. 7, an example is used where the first electrode of the light-emitting element 112 serves as the anode of the light-emitting element 112 and the second electrode of the light-emitting element 112 serves as the cathode of the light-emitting element 112. The voltage V12 of the reset signal Vref2 in the display stage Ta may be −0.9 V, and the voltage V11 of the reset signal Vref2 in the reset adjustment period Tf may be −2.3 V. In this case, the reset signal Vref2 provided by the display driving circuit 103 in the reset adjustment period Tf may have a smaller voltage value so that the first electrode of the light-emitting element 112 may be further reset. In this manner, the signal of the first electrode of the light-emitting element 112 may have a smaller voltage so that when the first power signal PVEE is an instantaneous negative pulse signal, it can also be ensured that the difference between the voltage of the reset signal Vref2 provided to the first electrode of the light-emitting element 112 and the voltage of the first power signal PVEE is less than the turn-on voltage of the light-emitting element 112, thereby ensuring that the light-emitting element 112 cannot emit light, preventing the display device 200 from flickering, and improving the display effect of the display device 200.

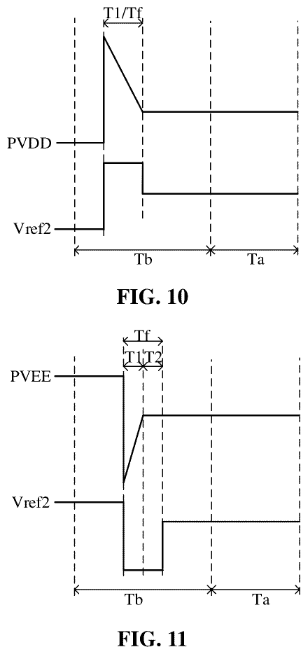

It should be noted that the duration of the reset adjustment period Tf may be equal to the duration of the power-on stage Tb. In this case, as shown in FIG. 7 or FIG. 8, the voltage V11 of the reset signal Vref2 in the entire power-on stage Tb is different from the voltage V12 of the reset signal Vref2 of the display stage Ta; alternatively, as shown in FIG. 9 and FIG. 10, the duration of the reset adjustment period Tf may be less than the duration of the power-on stage Tb, which is not specifically limited in the embodiments of the present disclosure on the premise that the absolute value of the voltage difference between the reset signal Vref2 and the first power signal in the power-on stage Tb is less than the turn-on voltage V0 of the light-emitting element 112. For ease of description, without special limitations, an example is used where the duration of the reset adjustment period Tf is less than the duration of the power-on stage Ta in the embodiments of the present disclosure for illustratively describing technical solutions in embodiments of the present disclosure.

In one or more embodiments, with continued reference to FIG. 1, FIG. 2, FIG. 4, FIG. 5, FIG. 9, and FIG. 10, the reset adjustment period Tf includes a first period T1; in the first period T1, the voltage of the first power signal (PVEE or PVDD) is V21; in the display stage Ta, the voltage of the first power signal (PVEE or PVDD) is V22, where V21/V22.

Since in the power-on stage Tb, the display driving circuit 103 provides the reset signal Vref2 to the reset module 15, and the reset module 15 can transmit the reset signal Vref2 to the first electrode of the light-emitting element 112 so that the first electrode of the light-emitting element 112 can be reset in the power-on stage Tb; meanwhile, in the display stage Ta, the display driving circuit 103 also provides the reset signal Vref2 to the reset module 15 so that in a reset sub-stage of one display driving cycle, when the reset module 15 is controlled to transmit the reset signal Vref2 to the first electrode of the light-emitting element 112, the signal at the first electrode of the light-emitting element 112 can be cleared to prepare the light-emitting element 112 for accurately emitting light when the light-emitting sub-stage is entered. Therefore, whether in the power-on stage Tb or in the reset sub-stage of the display stage Ta, the light-emitting element 112 does not need to emit light.

When the voltage V11 of the reset signal Vref2 provided by the display driving circuit 103 in the reset adjustment period Tf of the power-on stage Tb is different from the voltage V12 of the reset signal Vref2 provided by the display driving circuit 103 in the display stage Ta, the power management circuit 104 may provide the first power signal with the voltage V21 at least in the first period T1 of the reset adjustment period Tf and provide the first power signal with the voltage V22 in the display stage Ta, where V21 is different from the V22. In this manner, the absolute value of the difference between V21 and V11 is less than the turn-on voltage V0 of the light-emitting element 112, and the absolute value of the difference between V22 and V12 is less than the turn-on voltage V0 of the light-emitting element 112, to ensure that the light-emitting element 112 of the pixel 110 does not emit light in the power-on stage Tb and in the reset sub-stage of the pixel 110 in the display stage Ta, thereby improving the display effect of the display device 200.

It can be understood that the first period T1 may be any period in which the voltage V21 of the first power signal output from the power management circuit 104 is different from the voltage V22 of the first power signal in the display stage Ta. In an example embodiment, as shown in FIG. 9, the first period T1 may be a period in which instantaneous fluctuations occur when the power management circuit 104 starts to output the first power signal, such as a stage when the first power signal is a negative pulse or a positive pulse. An example is used where the first power signal is the negative power signal PVEE. At the start time of the first period T1, the power management circuit 104 starts to output the first power signal PVEE. However, since the device in the power management circuit 104 does not work stably or is interfered by the external signal, the first power signal PVEE output from the power management circuit 104 may suddenly spike. For example, the first power signal PVEE may instantaneously drop to −4.0 V. After that, the first power signal PVEE may gradually change from the instantaneous spike until the end time of the first period T1, and the first power signal PVEE may return to the normal voltage. The normal voltage may be understood as the voltage V22 of the first power signal PVEE that needs to be provided in the display stage Ta. For example, V22 may be −1.6 V. In this manner, since the first power signal PVEE changes between the instantaneous spike and the normal voltage in the first period T1, the voltage V21 of the first power signal PVEE provided by the power management circuit 104 in the first period T1 is different from the voltage V22 of the first power signal PVEE provided by the power management circuit 104 in the display stage Ta. In this case, by adaptively adjusting the voltage V11 of the reset signal Vref2 provided by the display driving circuit 103 in the first period T1, the voltage V11 of the reset signal Vref2 can be different from the voltage of the reset signal Vref2 provided by the display driving circuit 103 in the display stage Ta to ensure that the light-emitting element 112 does not emit light in the power-on stage Tb. Exemplarily, an example is used where the first electrode of the light-emitting element 112 serves as the anode, the second electrode of the light-emitting element 112 serves as the cathode, and the turn-on voltage V0 of the light-emitting element 112 is 2 V. The voltage V11 of the reset signal Vref2 in the reset adjustment period Tf may be −2.3 V, the voltage difference between the voltage V11 of the reset signal Vref2 and the minimum value (−4.0 V) of the voltage V21 of the first power signal PVEE in the first period T1 is 1.7 V, and the voltage difference (1.7 V) is less than the turn-on voltage V0 (2V) of the light-emitting element 112 so that the light-emitting element 112 cannot emit light. In the display stage Ta, the voltage V12 of the reset signal Vref2 may be −0.9 V, the voltage V22 of the first power signal PVEE may be −1.6, and the difference between the two is 0.7 V, which is still less than the turn-on voltage V0 of the light-emitting element 112. In this manner, when the reset module 15 is turned on and the reset signal Vref2 is provided to the first electrode of the light-emitting element 112, the light-emitting element 112 still cannot emit light.

It should be noted that the above only exemplifies the relationship between the reset signal Vref2 and the first power signal PVEE when the first power signal is a negative power signal PVEE. That is, when V21<V22, V11<V12 so that the reset signal Vref2 can increase with the increase of the voltage of the first power signal PVEE, thereby ensuring that the difference between the two is less than the turn-on voltage of the light-emitting element 112. In the embodiment of the present disclosure, as shown in FIG. 10, the first power signal may also be a positive power signal PVDD. In this case, the instantaneous spike of the first power signal PVDD may be a relatively high positive voltage, and the first power signal PVDD may slowly drop to a normal voltage after the instantaneous spike. At this time, in the reset adjustment period Tf, the voltage V11 of the reset signal Vref2 may also be a relatively high voltage, and in the display stage Ta, the reset signal Vref2 may be a relatively low voltage V12. That is, when V21>V22, V11>V12 so that the voltage of the reset signal Vref2 decreases as the voltage of the first power signal PVDD decreases, thus ensuring that the difference between the two is less than the turn-on voltage of the light-emitting element 112. Alternatively, in one or more other embodiments, the change trend of V11 and V12 may also be opposite to the change trend of V21 and V22, which is not specifically limited in the embodiments of the present disclosure on the premise that the absolute value of the voltage difference between the reset signal Vref2 and the first power signal PVDD is less than the turn-on voltage of the light-emitting element 112.

In addition, in one or more embodiments, when V21>V22, V11>V12. The voltage change trends of the first power signal in the first period T1 and the first power signal in the display stage Ta are the same as the voltage change trends of the reset signal Vref2 in the reset adjustment period Tf and the reset signal Vref2 in the display stage Ta. Thus, while it is ensured that the light-emitting element 112 cannot emit light in the power-on stage Tb, the voltages of the reset signal Vref2 and the first power signal in the display stage Ta closer to 0 V compared to the first period T1, thereby helping to reduce the overall power consumption of the display device 200. Alternatively, when V21<V22, V11<V12. In this manner, the voltages of the reset signal Vref2 and the first power signal in the display stage Ta closer to 0V, which is also conducive to reducing the overall power consumption of the display device 200.

It should also be noted that since the reset adjustment period Tf includes the first period T1, the duration of the first period T1 may be equal to the duration of the reset adjustment period Tf, or the duration of the first period T1 is less than the duration of the reset adjustment period Tf, which may be set as required.

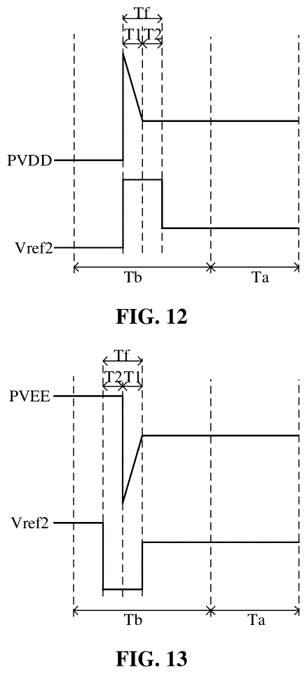

In one or more embodiments, FIG. 11 is a driving timing diagram of a display device according to an embodiment of the present disclosure, and FIG. 12 is another driving timing diagram of the display device according to an embodiment of the present disclosure. With reference to FIG. 11 and FIG. 12, the reset adjustment period Tf also includes at least one second period T2; in the at least one second period T2, the voltage of the first power signal is V23, where V21/V23.

Specifically, as shown in FIG. 11, when the first power signal is a negative power signal PVEE, an instantaneous spike negative voltage is present in the first power signal PVEE in the first period T1 so that the voltage of the first power signal PVEE in the first period T1 is smaller than the voltage of the first power signal PVEE in other periods. For example, the voltage V23 of the first power signal PVEE in the second period T2 may be greater than the voltage V21 of the first power signal PVEE in the first period T1. Moreover, since the voltage of the reset signal Vref2 in the reset adjustment period Tf is V11 and the reset adjustment period Tf includes the first period T1 and the second period T2, the voltages of the reset signal Vref2 in the first period T1 and the reset signal Vref2 in the second period T2 are both V11. Therefore, on the premise that the difference between the voltage V11 of the reset signal Vref2 and the voltage V21 of the first power signal PVEE in the first period T1 is less than the turn-on voltage V0 of the light-emitting element 112, in the second period T2, the difference between the voltage V11 of the reset signal Vref2 and the voltage V23 of the first power signal PVEE is also less than the turn-on voltage V0 of the light-emitting element 112, thereby preventing the light-emitting element 112 from emitting light in the power-on stage Tb. In this manner, by ensuring that the light-emitting element 112 cannot emit light in the reset adjustment period Tf, the display device 200 is prevented from flickering in the power-on stage, thereby improving the display effect of the display device 200.

In addition, when the reset adjustment period Tf includes the second period T2, the duration of the spike mutation of the first power signal PVEE is shorter than the duration of the reset adjustment period Tf so that the first period T1 when the first power signal PVEE undergoes a spike mutation and the second period T2 before and/or after the mutation are both in the reset adjustment period Tf when the reset signal Vref2 has a smaller voltage. In this manner, it is ensured that the voltage difference between the reset signal Vref2 and the first power signal PVEE can be smaller than the turn-on voltage V0 of the light-emitting element 112 so that the light-emitting element 112 cannot emit light in the power-on stage, and the display device 200 does not flicker, thereby improving the display effect of the display device 200.

It should be noted that the above description only exemplarily illustrates the technical solution of the embodiment of the present disclosure using an example where the first power signal is a negative power signal PVEE. In the embodiment of the present disclosure, when the first power signal is a positive power signal PVDD (as shown in FIG. 12), a similar technical effect can be achieved as when the first power signal is a negative power signal. The similarities may be referred to the above description and are not specifically limited here.

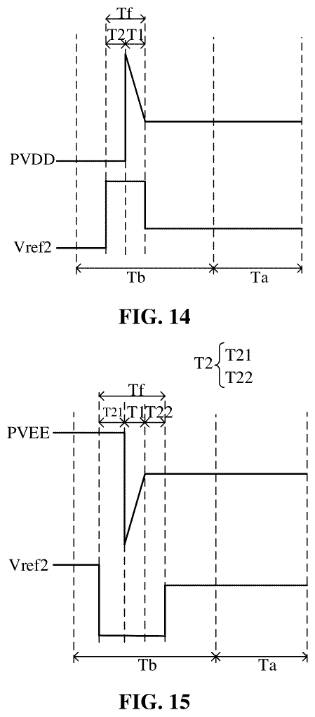

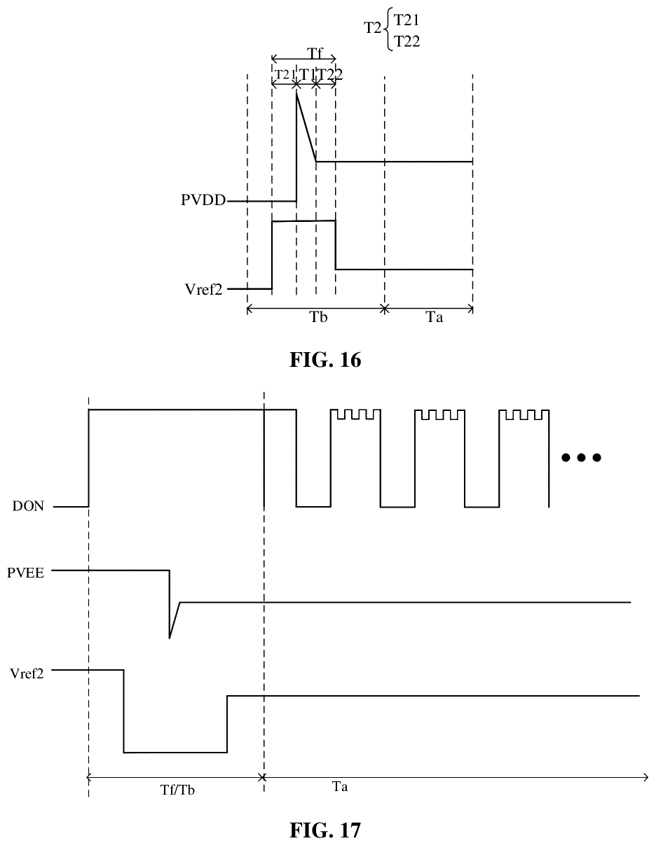

In addition, the reset adjustment period Tf may include a second period T2. The second period T2 is after the first period T1 (as shown in FIGS. 11 and 12), or the second period T2 may be before the first period T1 (as shown in FIGS. 13 and 14). Alternatively, the reset adjustment period Tf may include two second periods. One of the two second periods T2 may be before the first period T1, and the other second period T2 may be after the first period T1 (as shown in FIGS. 15 and 16). The number of second periods T2 and the relative relationship between the first period T1 and the second period may T2 be set as required and are not specifically limited here.

In one or more embodiments, with continued reference to FIG. 11 or FIG. 12, the second period T2 may be after the first period T1. In this manner, at the start time of the first period T1, the power management circuit can provide the first power signal PVEE while the display driving circuit can provide the reset signal Vref2 with a voltage of V11. Moreover, at the end period of the first period T1 and the start period of the second period T2, after the first power signal PVEE jumps from the voltage V21 to V23, the voltage of the reset signal Vref2 can still be maintained at V11 to ensure that in the entire reset adjustment period Tf, the absolute value of the voltage difference between the reset signal Vref2 and the first power signal PVEE can be maintained at a state where the value is less than the turn-on voltage V0 of the light-emitting element 112, thereby ensuring that the light-emitting element 112 does not emit light and improving the display effect of the display device 200.

In one or more embodiments, as shown in FIG. 11 and FIG. 12, when the second period T2 is after the first period T1, V22=V23. In this manner, the voltage V23 of the first power signal in the second period T2 can be the same as the voltage V22 of the first power signal in the display stage Ta so that after the power management circuit provides the voltage V23 of the first power signal in the second period T2, the power management circuit does not need to readjust the voltage of the first power signal after entering the display stage Ta. With this arrangement, the signal stability of the first power signal from the power-on stage Tb to the display stage Ta is improved, and the power consumption generated by charging or discharging the signal line in the display panel 100 due to adjusting the voltage of the first power signal is saved, thereby improving the display effect of the display device 200 in the display stage and reducing the power consumption of the display device 200.

In one or more other embodiments, as shown in FIG. 13 and FIG. 14, the second period T2 may also be before the first period T1. In this manner, in the second period T2, the power management circuit does not yet start to output the first power signal PVEE so that the terminal for outputting the first power signal PVEE in the power management circuit may be in a suspended state or may output a 0 V voltage signal, and the voltage of the reset signal Vref2 output from the display driving circuit has been adjusted to V11. Moreover, in the entire reset adjustment period Tf, the voltage of the reset signal Vref2 continues to remain at V11 so that after the second period T2 ends and the first period T1 is entered, the power management circuit starts to provide the first power signal PVEE, and when the first power signal PVEE has an instantaneous spike, it is ensured that the absolute value of the voltage difference between the reset signal Vref2 and the first power signal PVEE can be less than the turn-on voltage V0 of the light-emitting element 112, thereby ensuring that the light-emitting element does not emit light and improving the display effect of the display device 200.

In one or more embodiments, with continued reference to FIG. 13 and FIG. 14, when the second period T2 is before the first period T1, the relationship between the voltage V23 of the first power signal in the second period T2, the voltage V21 of the first power signal in the first period T1, and the voltage V22 of the first power signal in the display stage Ta may be set as follows: V23<V22<V21, or V21<V22<V23.

Exemplarily, as shown in FIG. 13, an example is used where the first electrode of the light-emitting element 112 is the anode, the second electrode of the light-emitting element 112 is the cathode, and the first power signal provided by the power management circuit 104 is the negative power signal PVEE. When the display device 200 is not started, for example, when the display device 200 is in the off state, each signal terminal of the display driving circuit 103 and each signal terminal of the power management circuit 104 may be suspended or output 0V voltage so that the power consumption of the display device 200 is 0 or the display device 200 has a lower power consumption. When the display device 200 needs to be started, the display device 200 enters the power-on stage, and each signal terminal of the display driving circuit 103 and each signal terminal of the power management circuit 104 start to output signals or start to output signals with a voltage not equal to 0 V. When the second period T2 of the power-on stage Tb is entered, the voltage at the signal terminal of the power management circuit 104 for outputting the first power signal PVEE may be the same as the voltage when the display device 200 is not started, that is, the voltage V23 of the first power signal PVEE output from the power management circuit 104 may be 0 V. In this case, the signal at the signal terminal of the display driving circuit 103 for outputting the reset signal Vref2 has changed from 0 V to a more negative voltage, that is, the display driving circuit 103 outputs the reset signal Vref2 with a voltage of V11 to prepare for entering the first period T1. In the first period T1, the power management circuit starts to output the negative first power signal PVEE. In this case, due to the instantaneous spike of the first power signal PVEE, the voltage V21 of the first power signal PVEE in the first period T1 is a smaller value, and the voltage V21 of the first power signal PVEE is less than the voltage V22 of the first power signal PVEE in the display stage Ta. At this time, the display driving circuit 103 continues to output the reset signal Vref2 with a voltage of V11 to ensure that the voltage V11 of the reset signal Vref2 is small enough in this period to ensure that the light-emitting element 112 cannot emit light. In the first period T1, the instantaneous negative spike of the first power signal PVEE gradually rises to the voltage of the normal negative power signal to prepare for the display stage Ta. After the display stage Ta is entered, the first power signal PVEE provided by the power management circuit 104 remains as a normal negative power signal, that is, the voltage V22 of the first power signal PVEE in the display stage Ta is less than the voltage V23 of the first power signal PVEE in the second period T2. In this manner, by adjusting the voltage of the reset signal Vref2 to V11 before the power management circuit 104 outputs the first power signal PVEE with a negative spike, it can ensure that the light-emitting element 112 cannot emit light in the entire power-on stage Tb, thereby improving the display effect of the display device 200 in the power-on stage Tb.

In another example embodiment, as shown in FIG. 14, an example is used where the first electrode of the light-emitting element 112 is the cathode, the second electrode of the light-emitting element 112 is the anode, and the first power signal provided by the power management circuit 104 is the positive power signal PVDD. When the display device 200 is not started, for example, when the display device 200 is in the off state, each signal terminal of the display driving circuit 103 and each signal terminal of the power management circuit 104 may be suspended or output 0V voltage so that the power consumption of the display device 200 is 0 or the display device 200 has a lower power consumption. When the display device 200 needs to be started, the display device 200 enters the power-on stage, and each signal terminal of the display driving circuit 103 and each signal terminal of the power management circuit 104 start to output signals or start to output signals with a voltage not equal to 0 V. When the second period T2 of the power-on stage Tb is entered, the voltage at the signal terminal of the power management circuit 104 for outputting the first power signal PVDD may be the same as the voltage when the display device 200 is not started, that is, the voltage V23 of the first power signal PVDD output from the power management circuit 104 may be 0 V. In this case, the signal at the signal terminal of the display driving circuit 103 for outputting the reset signal Vref2 has changed from 0 V to a more positive voltage, that is, the display driving circuit 103 outputs the reset signal Vref2 with a voltage of V11 to prepare for entering the first period T1. In the first period T1, the power management circuit 104 starts to output the positive first power signal PVDD. In this case, due to the instantaneous spike of the first power signal PVDD, the voltage V21 of the first power signal PVDD in the first period T1 is a larger value, and the voltage V21 of the first power signal PVDD is greater than the voltage V22 of the first power signal PVDD in the display stage Ta. At this time, the display driving circuit 103 continues to output the reset signal Vref2 with a voltage of V11 to ensure that the voltage V11 of the reset signal Vref2 is large enough in this period to ensure that the light-emitting element 112 cannot emit light. In the first period T1, the instantaneous negative spike of the first power signal PVDD gradually decreases to the voltage of the normal positive power signal to prepare for the display stage Ta. After the display stage Ta is entered, the first power signal PVDD provided by the power management circuit 104 remains as a normal positive power signal, that is, the voltage V22 of the first power signal PVDD in the display stage Ta is less than the voltage V23 of the first power signal PVDD in the second period T2. In this manner, by adjusting the voltage of the reset signal Vref2 to V11 before the power management circuit 104 outputs the first power signal PVDD with a positive spike, it can ensure that the light-emitting element 112 cannot emit light in the entire power-on stage Tb, thereby improving the display effect of the display device 200 in the power-on stage Tb.

In one or more embodiments, with reference to FIG. 15 and FIG. 16, when at least one second period T2 includes a first second period T21 and a second second period T22, the first second period T21 may be before the first period T1, and the second second period T22 may be after the first period T1. In this manner, before and after the first period T1 when the first power signal has a spike mutation, the voltage of the reset signal Vref2 can be controlled to be V11 so that the absolute value of the difference between the voltage of the reset signal Vref2 and the voltage of the first power signal is less than the turn-on voltage V0 of the light-emitting element 112. Thus, it is ensured that the light-emitting element 112 does not emit light in the reset adjustment period Tf, thereby improving the display effect of the display device 200 in the power-on stage Tb.

In one or more embodiments, in the first second period T21, the voltage of the first power signal is V231; in the second second period T22, the voltage of the first power signal is V232, where V232=V22, and V21<V232<V231, or V231<V232<V21.

Exemplarily, with reference to FIG. 15, when the first electrode of the light-emitting element 112 is the anode, the second electrode of the light-emitting element 112 is the cathode, and the first power signal provided by the power management circuit 104 to the cathode of the light-emitting element 112 is the negative power signal PVEE, the voltage V21 of the first power signal PVEE in the first period T1 may be less than the voltage V232 of the first power signal PVEE in the second second period T22, and the voltage V232 of the first power signal PVEE in the second second period T22 is less than the voltage V231 of the first power signal PVEE in the first second period T21. Thus, on the premise that the absolute value of the voltage difference between the voltage V11 and the voltage V21 of the reset signal Vref2 in the first period T1 is less than the turn-on voltage V0 of the light-emitting element 112, the voltage V231 of the first power signal PVEE in the first second period T21 is greater than the voltage V21 of the first power signal PVEE in the first period T1, to ensure that the absolute value of the voltage difference between the voltage V11 of the reset signal Vref2 and the voltage V231 of the first power signal PVEE in the first second period T21 is also less than the turn-on voltage V0 of the light-emitting element 112. Moreover, the voltage V232 of the first power signal PVEE in the second second period T22 is greater than the voltage V21 of the first power signal PVEE in the first period T1, to ensure that the absolute value of the voltage difference between the voltage V11 of the reset signal Vref2 and the voltage V232 of the first power signal PVEE in the second second period T22 is also less than the turn-on voltage V0 of the light-emitting element 112. In this manner, by setting that V21<V232<V231, it can be ensured that the light-emitting element 112 does not emit light in the entire reset adjustment period Tf to improve the display effect of the display device 200 in the power-on stage Tb. In addition, by setting the voltage V22 of the first power signal PVEE in the display stage Ta to be the same as the voltage V232 of the first power signal PVEE in the second second period T22, the power management circuit 104 does not need to adjust the voltage of the first power signal in the process of entering the display stage Ta from the second second period T22, thereby preventing the stability of the first power signal from being affected by the voltage adjustment and avoiding the extra power consumption caused by the voltage adjustment. Moreover, the signal stability of the first power signal from the power-on stage Tb to the display stage Ta is enhanced, the power consumption of the display device 200 is reduced, and the display effect of the display device 200 in the display stage Ta is improved.

In another example embodiment, with reference to FIG. 16, when the first electrode of the light-emitting element 112 is the cathode, the second electrode of the light-emitting element 112 is the anode, and the first power signal provided by the power management circuit 104 to the anode of the light-emitting element 112 is the positive power signal PVDD, the voltage V231 of the first power signal PVDD in the first second period T21 may be less than the voltage V232 of the first power signal PVDD in the second second period T22, and the voltage V232 of the first power signal PVDD in the second second period T22 is less than the voltage V21 of the first power signal PVDD in the first period T1. Thus, on the premise that the absolute value of the voltage difference between the voltage V11 and the voltage V21 of the reset signal Vref2 in the first period T1 is less than the turn-on voltage V0 of the light-emitting element 112, the voltage V232 of the first power signal PVDD in the second second period T22 is less than the voltage V21 of the first power signal PVDD in the first period T1, to ensure that the absolute value of the voltage difference between the voltage V11 of the reset signal Vref2 and the voltage V232 of the first power signal PVDD in the second second period T22 is also less than the turn-on voltage V0 of the light-emitting element 112. Moreover, the voltage V231 of the first power signal PVDD in the first second period T21 is less than the voltage V232 of the first power signal PVDD in the second second period T21, to ensure that the absolute value of the voltage difference between the voltage V11 of the reset signal Vref2 and the voltage V232 of the first power signal PVDD in the first second period T21 is also less than the turn-on voltage V0 of the light-emitting element 112. In this manner, by setting that V231<V232<V21, it can be ensured that the light-emitting element 112 does not emit light in the reset adjustment period Tf to improve the display effect of the display device 200 in the power-on stage Tb. In addition, by setting the voltage V22 of the first power signal PVDD in the display stage Ta to be the same as the voltage V232 of the first power signal PVDD in the second second period T22, the power management circuit 104 does not need to adjust the voltage of the first power signal in the process of entering the display stage Ta from the second second period T22, thereby preventing the stability of the first power signal from being affected by the voltage adjustment and avoiding the extra power loss caused by the voltage adjustment. Moreover, the signal stability of the first power signal from the power-on stage Tb to the display stage Ta is enhanced, the power consumption of the display device 200 is reduced, and the display effect of the display device 200 in the display stage Ta is improved.

It should be noted that the above illustrates the cases where the first power signal is a positive power signal PVDD or a negative power signal PVEE. In the embodiments of the present disclosure, the first power signal may be designed as required. For ease of description, without special limitations, other technical solutions in embodiments of the present disclosure are illustratively described using an example where the first power signal is the negative power signal PVEE.

In one or more embodiments, FIG. 17 is still another driving timing diagram of the display device according to an embodiment of the present disclosure. As shown in FIG. 17, the display driving circuit 103 is also configured to provide a display control signal DON and control start time of the reset adjustment period Tf and end time of the reset adjustment period Tf based on the time when the display control signal DON jumps to be a valid pulse.

The display control signal DON is a flag that can control the display device 200 to display a signal, that is, the display control signal DON may be understood as a flag that controls the display device 200 to start entering the power-on stage Tb. In this manner, when the display device 200 starts working, the display driving circuit 103 starts to output the valid pulse of the display control signal DON at the signal terminal for outputting the display control signal DON. In this case, the time of entering the power-on stage Tb can be determined based on the time when the display control signal DON jumps from a continuous invalid level to a valid pulse. After determining the time when the display device 200 enters the power-on stage Tb, the time when the power management circuit 104 starts to output the first power signal (PVDD or PVEE) may be estimated based on the time of entering the power-on stage Tb. Accordingly, when the power management circuit 104 starts to output the first power signal or before outputting the first power signal, the display driving circuit 103 can output a reset signal Vref2 with a lower or higher voltage so that the absolute value of the voltage difference between the reset signal Vref2 and the first power signal can be continuously smaller than the turn-on voltage V0 of the light-emitting element 112. In this manner, by enabling the display driving circuit 103 to control the duration of the reset signal Vref2 at a voltage of V11 based on the display control signal DON, the reliability of controlling the reset adjustment period Tf can be enhanced, thereby improving the display effect of the display device 200 in the reset adjustment period Tf.

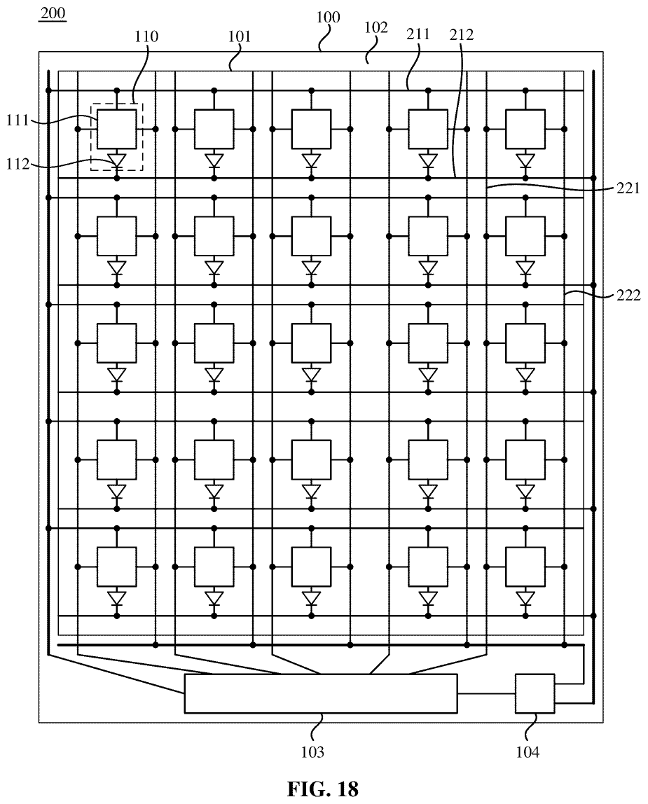

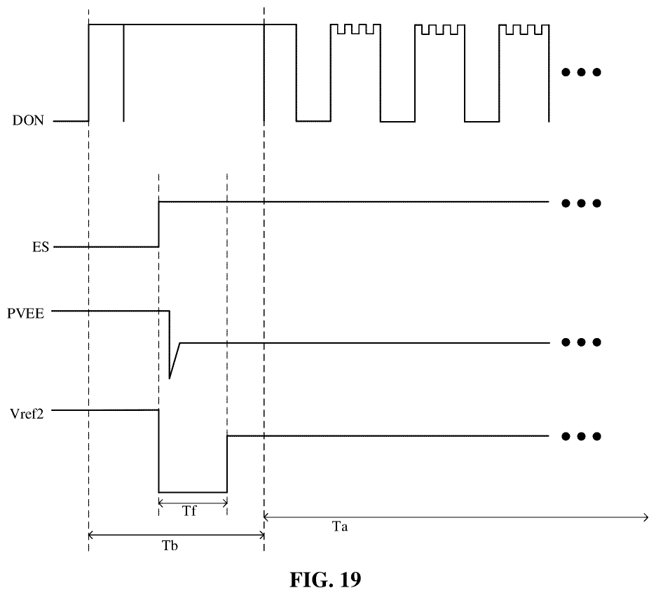

In one or more embodiments, FIG. 18 is another diagram illustrating the structure of the display device according to an embodiment of the present disclosure, and FIG. 19 is still another driving timing diagram of the display device according to an embodiment of the present disclosure. With reference to FIG. 18 and FIG. 19, the display driving circuit 103 is electrically connected to the power management circuit 104; the display driving circuit 103 is also configured to provide a first control signal ES to the power management circuit 104 and based on start time of enable level of the first control signal ES, control start time of the reset adjustment period Tf and end time of the reset adjustment period Tf; the power management circuit 104 is also configured to control the output of the first power signal PVEE based on the first control signal ES.

When the display driving circuit 103 is electrically connected to the power management circuit 104, the display driving circuit 103 may provide a first control signal ES to the power management circuit 104. When the power management circuit 104 receives the enable level of the first control signal ES, the power management circuit 104 may start to output the first power signal PVEE. Before the enable level of the first control signal ES is received, the signal terminal of the power management circuit 104 outputting the first power signal PVEE may continuously output 0V voltage. Therefore, based on the start time of the enable level of the first control signal ES, the time when the power management circuit 104 starts to output the first power signal PVEE may be determined. In this case, when the display driving circuit 103 provides the first control signal ES to the power management circuit 104, the display driving circuit 103 may control the voltage at the signal terminal for outputting the reset signal Vref2 from 0V to V11 so that the absolute value of the voltage difference between the reset signal Vref2 output from the display driving circuit 103 and the first power signal PVEE output from the power management circuit 104 can be less than the turn-on voltage V0 of the light-emitting element 112, thus ensuring that the light-emitting element 112 cannot emit light. In this manner, the display driving circuit 103 controls the duration for which the voltage of the reset signal Vref2 output from the display driving circuit 103 is set to V11 based on the duration of the enable level of the first control signal ES provided to the power management circuit 103. This arrangement ensures accurate control of the start time when the voltage of the reset signal Vref2 is set to V11.

In an example embodiment, the start time when the first control signal ES output from the display driving circuit 103 jumps to be the enable level may be the time when the power management circuit 104 starts to output the first power signal (PVEE or PVDD) with a non-zero voltage. In this case, the time when the voltage of the reset signal Vref2 output from the display driving circuit 103 jumps to be V11 may occur before the start time of the enable level of the first control signal ES or at the same time as the start time of the enable level of the first control signal ES. That is, the start time of the reset adjustment period Tf may be either before or at the same time as the start time of the enable level of the first control signal ES so that the absolute value of the voltage difference between the voltage V11 of the reset signal Vref2 and the voltage of the first power signal PVEE can remain smaller than the turn-on voltage V0 of the light-emitting element 112. This arrangement ensures that the light-emitting element 112 does not emit light in the power-on stage Tb, thereby improving the display effect of the display device 200.

It should be noted that the above only illustratively describes the start time of the reset signal with a voltage of V11 output from the display driving circuit 103 and the start time of the first power signal PVEE with a non-0V voltage output from the power management circuit 104. The embodiments of the present disclosure are not limited to the above description. The time when the voltage of the reset signal Vref2 output from the display driving circuit 103 becomes V11 and the start time when the power management circuit 104 outputs the first power signal PVEE with a non-0V voltage may be designed as required, and the embodiments of the present disclosure do not impose specific limitations.

It should also be noted that the above explanation is only exemplary by using an example where the reset signal Vref2 output from the display driving circuit 103 has a fixed voltage of V11 in the reset adjustment period Tf. In the embodiments of the present disclosure, the voltage V11 of the reset signal Vref2 output from the display driving circuit 103 may also be a variable voltage that may vary with the first power signal PVEE output from the power management circuit 104. The voltage may be designed as required, and the embodiments of the present disclosure do not impose specific limitations.

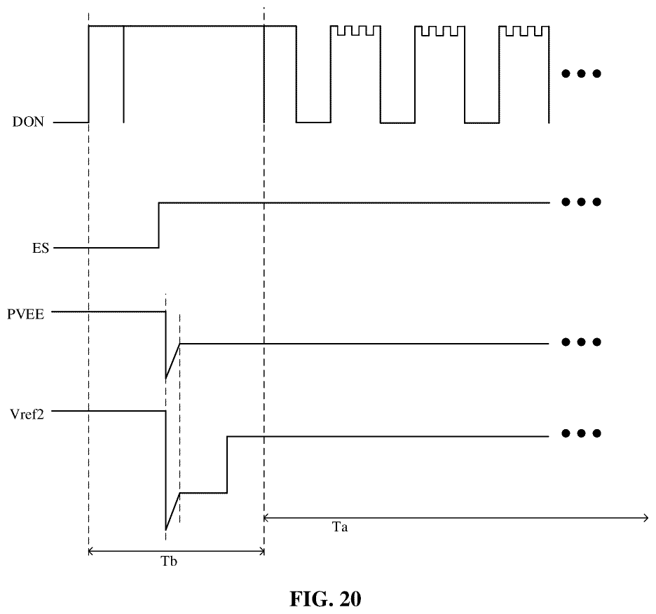

In one or more embodiments, with reference to FIG. 18 and FIG. 20, when the display driving circuit 103 is electrically connected to the power management circuit 104, the display driving circuit 103 may also be configured to receive the first power signal PVEE output from the power management circuit 104 and control the voltage of the reset signal Vref2 based on the first power signal PVEE. In this manner, after entering the power-on stage Tb, the power management circuit 104 can normally provide the first power signal PVEE, and the display driving circuit 103 can adaptively adjust the voltage of the reset signal Vref2 output from itself based on the received first power signal PVEE, thereby improving the control accuracy and reliability of the reset signal Vref2 and improving the display effect of the display device 200.

In an example embodiment, after entering the power-on stage Tb, if the voltage of the first power signal provided by the power management circuit 104 is 0 V, the display driving circuit 103 may output the reset signal Vref2 with a voltage of 0 V based on the first power signal to ensure that the absolute value of the voltage difference between the first power signal and the reset signal in this period is less than the turn-on voltage V0 of the light-emitting element 112. If the first power signal provided by the power management circuit 104 is a more negative non-zero voltage caused by an instantaneous spike, the display driving circuit 103 may calculate the instantaneous spike voltage of the reset signal Vref2 based on the negative voltage of the first power signal. This instantaneous spike voltage ensures that the voltage difference between the first power signal and the reset signal Vref2 remains smaller than the turn-on voltage V0. At this point, the display driving circuit 103 may output the reset signal Vref2 with the instantaneous spike voltage, ensuring that the light-emitting element 112 does not emit light even in the spike transition stage of the first power signal. If the voltage of the first power signal provided by the power management circuit 104 is a non-zero voltage, the display driving circuit 103 may calculate a set voltage that ensures the voltage difference between the first power signal and the reset signal Vref2 is smaller than the turn-on voltage V0 based on the voltage of the first power signal and the turn-on voltage V0. The display driving circuit 103 then outputs the reset signal Vref2 with the set voltage to ensure that the light-emitting element 112 does not emit light. In this manner, the display driving circuit 103 can adjust the voltage of the reset signal Vref2 in real time based on the voltage of the first power signal so that the light-emitting element 112 does not emit light in the power-on stage Tb, thereby improving the display effect of the display device 200.

In the display device provided by the embodiments of the present disclosure, in the power-on stage, the power management circuit is controlled to provide the voltage of the first power signal to the light-emitting element, and the display driving circuit is controlled to provide the voltage of the reset signal to the reset module so that the absolute value of the difference between the voltage of the reset signal provided to the first electrode of the light-emitting element of the display panel and the voltage of first power signal provided to the second electrode of the light-emitting element of the display panel is less than the turn-on voltage of the light-emitting element. In this manner, the light-emitting element cannot emit light in the power-on stage, and it is ensured that the display brightness of the light-emitting element is 0 grayscale, thereby avoiding the problem of screen flickering in the power-on stage of the display device and improving the display effect of the display device.

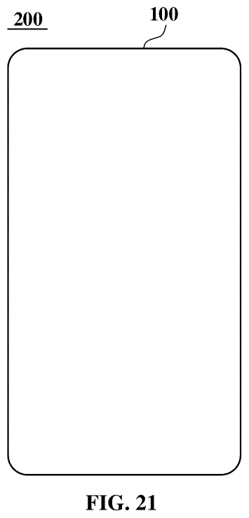

Exemplarily, FIG. 21 is another diagram illustrating the structure of the display device according to an embodiment of the present disclosure. As shown in FIG. 21, the display device 200 provided in the embodiment of the present disclosure may be any electronic product with a display function, including but not limited to phones, televisions, laptops, desktop displays, tablet computers, digital cameras, smart bracelets, smart glasses, vehicle-mounted displays, medical equipment, industrial control equipment, and touch interactive terminals. No special limitation is made thereto in embodiments of the present disclosure.

It is to be noted that the above are only preferred embodiments of the present disclosure and the technical principles used therein. It is to be understood by those skilled in the art that the present disclosure is not limited to the embodiments described herein. For those skilled in the art, various apparent modifications, adaptations, combinations, and substitutions can be made without departing from the scope of the present invention. Therefore, while the present disclosure is described in detail via the preceding embodiments, the present disclosure is not limited to the preceding embodiments and may include more equivalent embodiments without departing from the concept of the present invention. The scope of the present disclosure is determined by the scope of the appended claims.

What is claimed is:

1. A display device, comprising:
a display panel, wherein the display panel comprises a display area and a non-display area at least partially surrounding the display area, the display area is provided with a plurality of pixels arranged in array, a pixel of the plurality of pixels at least comprises a reset module and a light-emitting element, and the reset module is electrically connected to a first electrode of the light-emitting element;
a power management circuit disposed in the non-display area, wherein the power management circuit is at least configured to provide a first power signal to a second electrode of the light-emitting element; and
a display driving circuit disposed in the non-display area, wherein the display driving circuit is at least configured to provide a reset signal to the reset module;
wherein a working process of the display device at least comprises a power-on stage; in the power-on stage, a difference between a voltage of the reset signal and a voltage of the first power signal is ΔVb; and a turn-on voltage of the light-emitting element is V0, wherein |ΔVb|<V0.

2. The display device according to claim 1, wherein the working process of the display device further comprises a displaying stage, and the power-on stage comprises a reset adjustment period;
wherein in the reset adjustment period, the voltage of the reset signal is V11; and in the displaying stage, the voltage of the reset signal is V12; and
wherein V11≠V12.

3. The display device according to claim 2, wherein the reset adjustment period comprises a first period;
wherein in the first period, the voltage of the first power signal is V21; and in the displaying stage, the voltage of the first power signal is V22; and
wherein V21≠V22.

4. The display device according to claim 3, wherein the reset adjustment period further comprises at least one second period;
wherein in the at least one second period, the voltage of the first power signal is V23; and
wherein V21≠V23.

5. The display device according to claim 4, wherein the at least one second period is after the first period.

6. The display device according to claim 5, wherein V22=V23.

7. The display device according to claim 4, wherein the at least one second period is before the first period.

8. The display device according to claim 7, wherein V23<V22<V21, or V21<V22<V23.

9. The display device according to claim 4, wherein the at least one second period comprises a first second period and a second second period, the first second period is before the first period, and the second second period is after the first period.

10. The display device according to claim 9, wherein
in the first second period, the voltage of the first power signal is V231; and
in the second second period, the voltage of the first power signal is V232; and
wherein V232=V22, and V21<V232<V231, or V231<V232<V21.

11. The display device according to claim 3, wherein
when V21>V22, V11>V12; or when V21<V22, V11<V12.

12. The display device according to claim 2, wherein
the display driving circuit is further configured to provide a display control signal, and start time of the reset adjustment period and end time of the reset adjustment period are determined based on time when the display control signal jumps to be a valid pulse.

13. The display device according to claim 2, wherein the display driving circuit is electrically connected to the power management circuit;
the display driving circuit is further configured to provide a first control signal to the power management circuit and control start time of the reset adjustment period and end time of the reset adjustment period based on start time of enable level of the first control signal; and
the power management circuit is further configured to control an output of the first power signal based on the first control signal.

14. The display device according to claim 1, wherein the working process of the display device further comprises a displaying stage; and
in the displaying stage, a difference between the voltage of the reset signal and the voltage of the first power signal is ΔVa, wherein ΔVa|<V0.

15. The display device according to claim 14, wherein |ΔVb|≤|ΔVa|.

16. The display device according to claim 1, wherein the display driving circuit is electrically connected to the power management circuit; and
the display driving circuit is further configured to receive the first power signal output from the power management circuit and control the voltage of the reset signal based on the first power signal.

17. The display device according to claim 1, wherein the working process of the display device further comprises a displaying stage;
the display driving circuit is further configured to provide a respective data signal for each of the plurality of pixels in the displaying stage; and
the pixel further comprises a drive module, and the drive module is configured to selectively provide a drive current to the light-emitting element based on the respective data signal.
